(19) United States
(12) Patent Application Publication
(10) Pub. No.: US 2010/0141724 A1
(43) Pub. Date: Jun. 10, 2010

(54) Ink-Jet Recording Apparatus, Ink-Jet Recording Method and Ultraviolet Ray Curable Ink

(76) Inventor: Atsushi Nakajima, Hachioji-shi (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 11/884,257

(22) PCT Filed: Jan. 23, 2006
(86) PCT No.: PCT/JP06/00927

§ 371 Date: Aug. 13, 2007

(30) Foreign Application Priority Data
Feb. 24, 2005 (JP) 2005-048715

(51) Int. Cl. B41J 2/01; C08F 2/46

(52) U.S. Cl. 347/102; 522/167; 522/71

(57) ABSTRACT

Disclosed are an inkjet recorder and inkjet recording method wherein the problem of image quality degradation caused when an image formed of an ultraviolet-curable ink employing no aqueous solvent is cured using flash light is solved, and a high-gloss high-quality image can be attained quickly while eliminating deterioration in density and adhesion to a recording medium. With such an inkjet recorder and inkjet recording method, a high-quality image can be similarly attained even in case of a color image containing an ink of different infrared absorption such as a black ink. Also disclosed is an ultraviolet-curable ink used in such an inkjet recorder and inkjet recording method. The inkjet recorder comprises a flash light source, and is characterized by comprising a means for attenuating the quantity of light at least in a part of infrared wavelength region of flash light emitted from the flash light source.

### FIELD OF THE INVENTION

The present invention relates to a novel ink-jet recording apparatus, an ink-jet recording method and an ultraviolet ray curable ink used with them.

### BACKGROUND OF THE INVENTION

An ink image which can be fixed by an ultraviolet ray is formed via an ink-jet system, and a recording method to irradiate an ultraviolet ray to fix data has been developed in recent years, and the practical application is still progressing. Ink techniques now used, which are described in WO99/29787, WO99/29788, and WO97/31071, Unexamined Japanese Patent Application Publication Nos. (hereinafter, referred to as JP-A) 5-214280 and 2002-188025, are known.

Since an ultraviolet ray curable ink functions via a curing reaction of photo polymerization on a recording medium by exposure of actinic radiation, such as ultraviolet rays, the UV curable ink can be fixed and can form a permanent picture image on a recording medium which does not absorb ink, for example, on a plastic surface at sufficient adhesion.

However, to sufficiently irradiate ultraviolet rays sufficiently for the curing reaction after deposition of the ink on a base support (being a recording medium), a comparatively large ultraviolet light source is required near the printing section, for which usually a high pressure mercury lamp is employed. Further, since these ultraviolet light sources emit not only ultraviolet rays, but also simultaneously visible rays and infrared rays simultaneously, the portions of the apparatus near the light source are heated considerably. Therefore, the portions near the recording head and the recording medium tend to overheat, and thus it requires counter-measures to be taken.

On the other hand, some attempts using flashes of light have been made in the ink-jet recording method. For example, in Patent Document 1, use of flashes of light is described to fasten drying of the ink in the ink-jet recording method.

Further, in Patent Document 2, a water based light-flash curable ink-jet ink exhibiting high affinity for plastic resins, such as flexible polyvinyl chloride resin, is described, and the ink is cured via flashed light exposure.

However, in Patent Document 1, there is neither description of an ink composition nor ink characteristics, which are suitable for this method, and the description is only with respect to acceleration of drying/evaporation of the solvents using a Light-flash source on the solvent-based ink, such as a water-based ink and a non-water based solvent ink. In this case, a substantial amount of heat is required to dry/evaporate the ink (namely for evaporation of water or a solvent), requiring numerous exposures of the light-flash source.

In Patent Document 2, described is a proposal in which an image is formed on a flexible plastic film support, such as vinyl chloride, exhibiting sufficient adhesion by using an ultraviolet ray curable ink containing water, and with multiple exposures of the flashing lamp. From flash exposure, the heat value of the base support may be decreased, compared to the case when using the usual high-pressure mercury lamps. Also, described is a high satisfactory fixability ink, in which a hydrophilic monomer capable to soften vinyl chloride, is incorporated. Since the ink is an ultraviolet ray curable ink, it is possible to cure the ink on the base support without need of a large amount of heat to evaporate water as a solvent. Because of the short time exposure via a light-flash source, energy can be controlled only onto the upper surface of the base support, resulting in suppressed thermal diffusion to the base support. Therefore, it is assumed to be effective to evaporate water in the ink, even on plastic film which tends to easily be deformed via heat.

However, in the foregoing ultraviolet ray curable ink, containing water described above, a very large amount of heat is required to eliminate any residual moisture, and thus, it is difficult to obtain sufficient image permanence due to said residual moisture. Further, vaporization of the solvent such as water is not complete because vaporization is momentary curing. Therefore, the solvent remaining in the cured layer results in deterioration of desired film characteristics. A great amount of heat is needed to eliminate the solvent from the once polymerized layer.

[Patent Document 1] JP-A 2000-272101

[Patent Document 2] Japanese Translation of PCT International Application Publication No. 2001-512777

### DISCLOSURE OF THE INVENTION

### Object of the Invention

When curing the ultraviolet ray curable ink which does not incorporate a water solvent using flashes of light, there is no solvent to be evaporated. However, as curing is actually carried out, the emitted energy of the flashing lamp is quite large, and since the emission wavelength covers wide range over the visible-spectrum, other problems are produced and it has been an on-going task that counter-measures to solve them are still required.

Since the ultraviolet ray curable ink containing no water exhibits a large heat capacity and evaporative latent heat, if the infrared component contained in a light-flash source is absorbed in the ink droplets, the ink droplet shape is deformed by heating or some ingredients of the ink are evaporated, resulting in deterioration of image quality. Specifically, a black ink exhibits a high light absorption efficiency, whereby convection flow of ink and boiling of monomers may occur by overheating before and after ink curing, resulting in tendency of image quality deterioration due to lowered glossiness, lowered density and decreased adhesion.

That is, in studies by the inventor, since emissions of the flash lamp also cover the visible regions through the infrared regions, overheating of the ink is caused by absorption of much light energy for a short time of the flashed light. The thermal energy is preferably used for acceleration of photopolymerization, however, if flashed light energy is high, a balance between the heating rate of ink and heat transfer (thermal convection) to the interior of the ink droplet is disrupted to cause a locally-overheated state in only the ink layer surface, which are supposed to lead to wrinkling and uneven coloring of the cured ink layer due to ink boiling or thermal convection, and resulting in deterioration of image quality. It turns out that when a specific black ink, which strongly absorbs infrared rays, is employed with color inks exhibiting low absorption, it is very difficult to suppress deterioration of image quality by absorption of infrared rays while keeping almost identical ultraviolet curable sensitivity in each of the color inks.

The present invention has been achieved to solve the above problems. An object of this invention is to provide an ink-jet recording method, with which method a problem of image quality deterioration, caused by flashed light curing of an image, which is formed with a ultraviolet ray curable ink containing no water solvent, is overcome, and the resulting image exhibits high glossiness, negligible density loss, degradation-free adhesion onto a recording medium, rapidly obtained high image quality, as well as high color image quality via color inks exhibiting differing infrared absorption rates. Another object of this invention is to also provide an ink-jet recording apparatus, and to provide an ultraviolet ray curable ink using them.

### Means to Solve the Problem

The above-cited object of the present invention was attained by the following composition.

Item 1. An ink-jet recording apparatus which is equipped with a light-flash source,

wherein the ink-jet recording apparatus has a device to reduce an amount of light within at least an infrared wavelength region emitted from the light-flash source.

Item 2. The ink-jet recording apparatus described in Item 1 above, wherein the device to reduce the amount of light within the infrared wavelength region is a device to reduce at most by half the amount of light at 800-1,100 nm.

Item 3. An ink-jet recording method comprising the steps of:

(a) ejecting an ultraviolet ray curable ink onto a recording medium, and

(b) curing to fix the ejected ink using flashing light emitted from a light-flash source,

wherein the flashing light is one at least a part of the amount of light which is reduced in the infrared wavelength region.

Item 4. The ink-jet recording method described in Item 3 above, wherein the flashing light is one an amount of light which is reduced to at most ½ in the wavelength region of 800-1,100 nm.

Item 5. The ink-jet recording method described in Item 3 or 4, wherein ratio (B/A), amount of light (B) at 800-1,100 nm of the wavelength of the flashing light to amount of light (A) at 250-450 nm of wavelength, is at most half.

Item 6. The ink-jet recording method described in any one of Items 3-5, wherein the total content of water and a water soluble solvent in the ultraviolet ray curable ink is at most 5 weight % based on the total weight of the ultraviolet ray curable ink.

Item 7. The ink-jet recording method described in any one of Items 3-6, wherein an image is formed using two or more kinds of ultraviolet ray curable inks which exhibit different infrared absorption capability.

Item 8. An ultraviolet ray curable ink being used for ink-jet recording method of any one of Items 3-7.

Item 9. The ultraviolet ray curable ink described in Item 8 above, wherein the total content of water and a water soluble solvent in the ultraviolet ray curable ink is at most 5 weight % based on the total weight of the ultraviolet ray curable ink.

### EFFECTS OF THE INVENTION

According to this invention, the drawbacks of the image quality deterioration caused by curing the ultraviolet ray curable ink using a flashing light are overcome, and high glossiness, maintained density, no deterioration of adhesion to the recording medium, and a highly defined image quality is obtained quickly, are realized. In addition, the ink-jet recording apparatus and ink-jet recording method with which a highly defined image quality is similarly obtained in color images using inks which exhibit differing infrared ray absorption, such as black ink, and the ultraviolet ray curable ink used for them were realized.

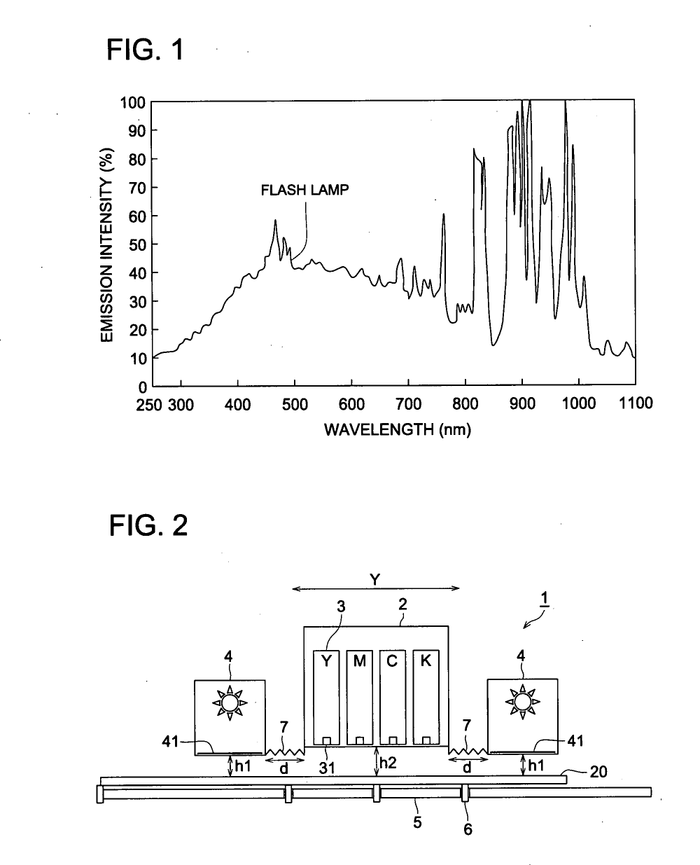

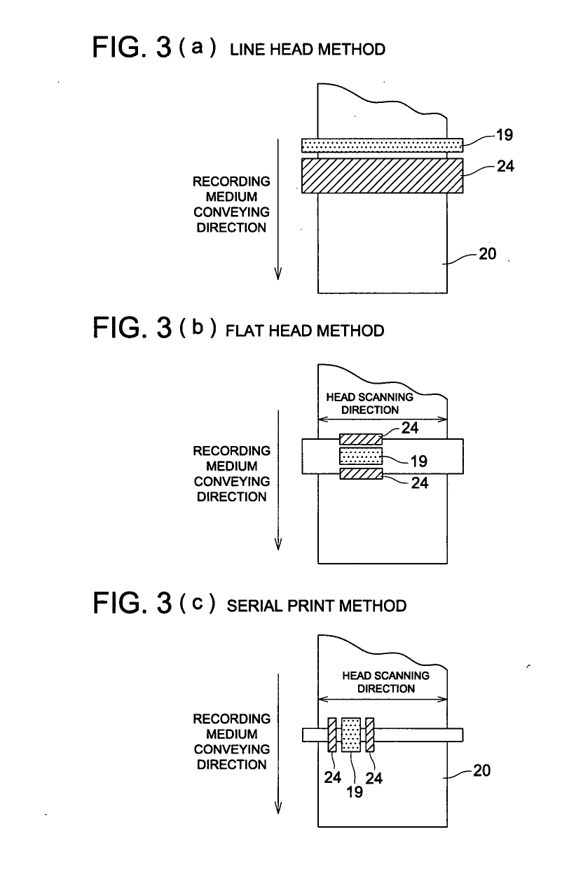

### BRIEF DESCRIPTION OF DRAWINGS

[FIG. 1] Showing an emission-spectrum figure of a light-flash source.

[FIG. 2] A front view showing principal parts of an example of the composition of the ink-jet recording apparatus of this invention.

[FIGS. 3(a), 3(b), 3(c)] Schematic diagrams each showing an example of other ink-jet recording apparatuses.

### DESCRIPTION OF NUMERICAL DESIGNATIONS

1. Recording Apparatus
2. Head Carriage
3 and 19. Recording Heads
4 and 24. Light-flash Sources
5. Platen Section
6. Guide Member
20. Recording Medium
41. Infrared Light Cut-Off Filter

### PREFERABLE EMBODIMENTS OF THE INVENTION

Next, the preferable embodiments of this invention will be described, but the present invention is not limited thereto.

In the present invention, an image is formed by using an ultraviolet ray curable ink, which is cured to fix the image after the ink has been deposited onto a recording medium. As an ultraviolet light-source to cure the ultraviolet curable ink, a light-flash source is employed to cure the ultraviolet ray curable ink in a short time and to fix the ink to the recording medium.

As a result of inventor's diligent investigation regarding the above problems, it was found that by curing deposited ink droplets or a formed ink image to a recording medium using a light-flash source, which is reduced infrared-rays, without overheating of the ink droplets or the ink image, it is possible to fix the image without causing color unevenness, which is a drawback of fixing via the forgoing flashing light, due to ink boiling, ink evaporation, or an excess of convection between the ink interior and ink surface, due to overheating of ink or ink surface.

Hereafter, the details of the present invention are described.

### [Light-Flash Source]

As a light-flash source of this invention, although there is no particular restriction, a xenon flash is typical, for example. As for the surface of tube and filter of a light-source lamp, in order to efficiently use ultraviolet rays, it is preferable to use ultraviolet permeable ones. As mentioned above, generally a light-flash source is over a short-time emission of at most 1 msec., and the amount of energy per unit area per unit time of the light-flash, illuminance is extremely large. Further, the flashing light includes visible through infrared region light in addition to ultraviolet components which contribute mainly to polymerization reaction (being a curing reaction) of the ultraviolet curable ink. Such irradiated light is absorbed into the ink or recording medium, tending to overheat of the ink to result in problems, such as ink boiling (being ink popping), or evaporation to blow the monomer components.

When too much energy is exposed to an ink droplet, such as high illuminance infrared rays over a short time, the infrared light is absorbed mainly into the surface portion of the ink and converted to heat, and at the same time, since diffusion of thermal energy to the interior of the ink droplet is comparatively slower than the irradiation time of the flashing light, thermal diffusion in the ink depth (being in the range of several to more than a dozen μm) is not sufficient, resulting in ink surface overheating, leading to problems of ink boiling at the ink surface and evaporation of monomers. Further, in connection with temperature difference between the ink surface portion and the ink drop interior, excessive convection is caused to result in uneven ink density and curing wrinkles formed on the ink image.

The emission spectrum of the light-flash source of this invention covers a large range of emitted light, also in the infrared light region, in addition to the ultraviolet region, as shown, for example, in FIG. 1. In this invention, “the flashing light from which the infrared light is reduced” device the light is reduced in the wavelength range of 800-1,100 nm by no more than ½ from that of the light-flash source.

Further, specifically preferable is the flashing light exhibiting the ratio (B/A), namely light amount (B) in a wavelength region of 800-1,100 nm to light amount (A) in a wavelength region of 250-450 nm is less than ½.

In this invention, measurement of spectral energy distribution of the above flashing light, for example, OL-745, a meter for ultraviolet-visible-near-infrared-radio waves (manufactured by Kyokko Trading Co., Ltd.), can be employed. Specifically, the spectrums measured by using OL-745-PMT and OL-745-Si are composed.

The ink-jet recording apparatus of this invention is characterized by having a device which reduces at least some amount of the light of the infrared wavelength region, and as a specific device, there is no particular limitation, but it is preferable to apply a filter which blocks the light of the visible ray region or the infrared light region. As a filter which blocks the light of the visible light region or the infrared light region, are for example, various optical filters, such as a colored glass filter, a dielectric film filter, and an interference filter, may be suitably employed. Specifically, preferred is the cold filter which is coated with a dielectric film filter on heat-absorptive glass. As such cold filters, for example, one, which is commercially available from Sigma Koki Co., Ltd., may be utilized. Further, an ND filter may be employed when a device to control the total amount of light is incorporated.

In this invention, as emitted energy of the flashing light which is reduced in the infrared range, it is preferably in the range of 0.1-10 J/cm²(per flash), and the emission time of the flashing light is preferably in the range of 0.5-5 ms.

As a light-flash source employed in the present invention, a xenon flash lamp is common, and a xenon rectangular pulse light-source may also be employed, but preferred is one which has an emission time of 0.5-1 msec. Further, various strobe-light sources may be employed. For example, light emission of high illumination over a short time may be obtained employing a xenon flash lamp, in which Xe gas is encapsulated in a glass tube, and electrodes are installed on both ends of the glass tube, and a trigger electrode is on the tube wall. When a trigger voltage is applied to the trigger electrode while a predetermined voltage is applied between the main electrodes from a flash power source, insulation in the tube is overcome to start immediate main discharge between the main electrodes, resulting in light-flash emission at a quantified period from the ultraviolet toward the infrared regions.

Emission time of the flashing light generally increases when power input per flash is large, and conversely when small, it becomes shorter. So, it is necessary to select a suitable light-flash source, in order to exhibit a certain emission intensity to generate sufficient ink curing and to exhibit a relatively long emission time. Further, as described in JP-A 2001-142347, the light-flash source and its driving circuit are designed to create a relatively long emission time of the flashing light under assured power input. That is, emission time may be controlled, for example, via appropriate selection of the flash lamp or a device of circuit such as a charging condenser capacity, and a charging voltage.

As examples of these flash lamps, a xenon flash lamp is typical. For example, employed may be a xenon lamp manufactured by Hamamatsu Photonics K.K., Xenon Lamp SXC-150L, manufactured by Nissin Electronics Co., Ltd., Hard Glass & Quartz Xenon Flash Lamp for copy machines and printers, manufactured by Miyata Elevam, Inc., and XZ series Xenon Lamp, manufactured by Patlite Corp.

### [Ultraviolet Ray Curable Ink]

In the ultraviolet ray curable ink of this invention, the total content of water and water soluble solvent in the ink is preferably at most 5.0 weight %. If large amount of water and water soluble solvent are contained, these solvents remain in the ink layer after the ink is cured, resulting in deterioration of image durability. In addition, since monomers are polymerized after ink curing, diffusion potential of the solvents are lowered in the ink, and thus a relatively large amount of heat is needed to volatilize these solvents. Therefore, it is preferable that the content of water and water soluble solvent in the ink is minimal.

In addition, when water and a water soluble solvent are added to the ink, it is preferable that the amount is brought to at most 5.0 weight %, and also that the ink is subjected to a solvent removal treatment by heating the ink in advance, before the ink is exposed to the flashing light.

The water soluble solvents of this invention are those which are not polymerizable and which have a solubility in water of 10 weight % or more at 25° C., or which mix freely with water, and examples of these solvents include alcohols, acetones, and ethylene glycols.

There are two types of ultraviolet ray curable inks, namely a radical polymerizable and a cationic polymerizable type based on the reaction mechanism, and either type may be used in the present invention. However, ultraviolet ray curable inks exhibiting a fast polymerization rate, via a radical polymerizable compound, are preferable from the viewpoint of reactivity over a short time irradiation, such as a light-flash.

Although radical polymerizable ink exhibits curing inhibition by oxygen, when short-time and high illuminance exposure is conducted via a light-flash as in this invention, sensitivity can be enhanced dramatically. As preferable illuminance, the mean value of incident light energy per unit of emission time (being in peak width half the height) is at least 250 W/cm², but more preferably at least 500 W/cm². By raising illuminance, oxygen inhibition can be decreased and the curing rate can be increased. However, if it raises only illuminance, intensity of the infrared light also increases, and especially, in black ink image formation, the overheat phenomenon will result and image quality will deteriorate.

The ultraviolet ray curable ink of this invention may be prepared by dispensing/dispersing a dispersing agent, coloring materials, and other appropriate additives into photo polymerizable components, such as photo polymerizable compounds, and photo polymerization initiators.

As photo polymerizable compounds, being examples of radical polymerizable compounds, listed are the compounds described in, for example, JP-A Nos. 7-159983, 8-224982, and 10-863, as well as Examined Japanese Patent Application Publication No. (hereinafter, referred to as JP-B) 7-31399.

Specifically, as examples of radical polymerizable compounds, cited may be aliphatic (meth)acrylate, alicyclic (meth)acrylate, aromatic (meth)acrylate, ether system (meth)acrylate, vinyl monomers, and (meth)acryl amides. “(Meth)acrylate” means a compound containing at least one kind of any acrylate or methacrylate.

Examples of a compound having an ethylenically unsaturated bond and capable radical polymerization include, for example, an unsaturated carboxylic acid, such as acrylic acid, methacrylic acid, itaconic acid, crotonic acid, and isocrotonic acid, and a salt, ester, amide and anhydride thereof; urethane; acrylonitorile; styrene; and further, various radical polymerimerizable compounds, such as unsaturated polyesters, unsaturation polyethers, unsaturation polyamides, and unsaturated urethane.

Specifically listed are: acrylic acid derivatives, such as 2-ethylhexyl acrylate, 2-hydroxyethyl acrylate, butoxy ethyl acrylate, carbitol acrylate, cyclohexyl acrylate, tetrahydrofurfuryl acrylate, benzyl acrylate, bis (4-acryloxy polyethoxy phenyl)propane, neopentyl glycol diacrylate, 1,6-hexanediol diacrylate, ethylene glycol diacrylate, diethylene glycol diacrylate, triethylene glycol diacrylate, tetraethylene glycol diacrylate, polyethylene glycols diacrylate, polypropylene glycol diacrylate, pentaerythritol triacrylate, pentaerythritol tetraacrylate, dipentaerythritol tetraacrylate, trimethylol propane triacrylate, tetramethylolmethane tetraacrylate, oligoester acrylate, N-methylolacrylamide, diacetone acrylamide, and epoxy acrylate; methacrylic acid derivatives, such as methyl methacrylate, n-butyl methacrylate, 2-ethylhexyl methacrylate, lauryl methacrylate, allyl methacrylate, glycidyl methacrylate, benzyl methacrylate, dimethylamino methylmethacrylate, 1,6-hexanediol dimethacrylate, ethylene glycol dimethacrylate, triethylene glycol dimethacrylate, polyethylene glycol dimethacrylate, polypropylene glycol dimethacrylate, trimethylolethane trimethacrylate, trimethylol propane trimethacrylate, 2,2-bis(4-methacryloxy polyethoxy phenyl)propane; and in addition to these, allyl compound derivatives, such as allyl glycidyl ether, diallyl phthalate, and triallyl trimellitate. Further, more specifically, radical polymerizable or cross-linkable monomers, oligomers, and polymers which are commercially available or well-known in the art, are employable, and these compounds are described in “Cross-Linking Agent Handbook”, edited by Shinzo Yamashita (1981, published by Taiseisha, Ltd.); “UV-EB Curing Handbook (raw material edition)”, edited by Kiyoshi Kato (1985, published by Koubunnshi Kankoukai); “Application of UV-EB Curing Technology and Marketing”, page 79, edited by RadTech Japan, (1989, published by CMC Publishing Co., Ltd.); “Polyester Resin Handbook”, Eiichiro Takiyama, (1988, published by The Nikkan Kogyo Shimbun, Ltd.).

The added amount of a radical polymerizable compound to the ultraviolet ray curable ink is preferably 1-97 weight % based on the total weight of the ink, but more preferably 30-95 weight.

In this invention, as any coloring material which can be dissolved or dispersed into the above photo polymerizable compound may be employed, but from the weather resistance viewpoint, a pigment is preferably employed.

Pigments, preferably employed in this invention, are described in JP-A 2004-131588, paragraph [0086].

For the purpose of dispersion of the above pigments, such as a ball mill, a sand mill, an attriter, a roll mill, an agitator, a Henschel mixer, a colloidal mill, an ultrasonic homogenizer, a pearl mill, a wet-jet mill and a paint shaker may be utilized. Further, it is also possible to incorporate a dispersing agent when dispersing the pigment. As a dispersing agent, it is preferable to utilize a polymer dispersing agent. Specific examples of these dispersing agents and auxiliary dispersing agents are described in above JP-A 2004-131588, paragraphs [0088]-[0093].

These dispersing agents and auxiliary dispersing agents are preferably added in an amount of 1-50 weight parts based on 100 weight parts of pigment. Dispersion of the pigment is conducted using a solvent or a polymerizable compound, but, in the ultraviolet ray curable ink of this invention, it is preferable that the content of water or water soluble solvent as a dispersing medium is at most 5 weight %, but actually, no solvent is preferred, in order to react/cure the ink in the shortest time, when considering deterioration of solvent resistance and adverse effects of volatilization of any residual solvent. Therefore, for a dispersion medium, it is preferable to select a polymerizable compound, but more preferable to select a monomer exhibiting the lowest viscosity from the dispersion suitability viewpoint.

In dispersion of pigment, it is preferable that the average diameter of pigment particles is 0.08-0.5 μm, and selection of a pigment, a dispersing agent, and a dispersion medium, as well as dispersing conditions and filtration requirements are appropriately set up so that the maximum particle diameter between 0.3-10 μm, but preferably 0.3-3 μm. With this particle diameter control, nozzle orifice clogging of the ink-jet recording head is reduced, and storage stability of ink, ink transparency, and sensitivity of curing can be maintained.

In the ultraviolet ray curable ink of this invention, the added amount of coloring material is preferably 1-10 weight % based on the total weight of the ink.

In this invention, to conduct an image curing reaction more efficiently, a photo polymerization initiator is added to cure the ink. A photo polymerization initiator is a radical generator, and such radical generators may be divided roughly into two kinds, namely an intramolecular bond-cleavage type and an intramolecular hydrogen-withdrawing type.

Examples of these radical generators are the compounds described in JP-A 2004-131588, paragraphs [0073]-[0074].

The added amount of the radical generator is usually preferable in the range of 0.01-10.00 weight % in the ink composition. However, because of high illuminance exposure by the flashing light in this invention, the usual added amount of a photo polymerization initiator increases reaction starting points, resulting in a lowered degree of polymerization. To prevent this, the added amount of the photo polymerization initiator (being a radical generator) is more preferably in the range of 0.01-3.0 weight % of the ink composition.

Further, the ultraviolet ray curable ink of this invention is cured by irradiation of ultraviolet rays, and to conduct the curing reaction, a photo-sensitizer may be added. As such a photo-sensitizer, cited are the compounds listed in JP-A 2004-131588, paragraph [0085]. The added amount of the photo-sensitizer is 0.01-10.0 weight % of the ink composition, but preferably in the range of 0.01-3.0 weight %.

Other than these components, the ultraviolet ray curable ink of this invention may contain an appropriate surface active agent, a leveling additive, and a matting agent, and also to adjust surface properties, may contain polyester resin, polyurethane resin, vinyl resin, acrylic resin, rubber system resin, and waxes.

Further, it is also preferable to add into the ink a polymerization inhibitor to control polymerization via heat or actinic radiation. As preferable examples of polymerization initiators, added may be various anti-oxidization agents (being AO agents), nitrosamine compounds, and hydroquinone compounds. Specifically, for example, MEHQ (being p-methoxy phenol) may be employed.

Excessive addition of these polymerization inhibitors may cause deterioration of ink sensitivity, and thus, it is desired to determine the appropriate amount of the polymerization inhibitor to prevent polymerization during dispersion of the pigment, while maintaining storage stability of the ink. The added amount of polymerization inhibitor in the ink is preferably 200-20,000 ppm.

In addition, in order to improve the ink adhesion to the recording medium (also referred to as a base material or a support) after the ink is cured by ultraviolet rays, it is also effective to add an organic solvent of an infinitesimal amount. In this case, addition of the organic solvent is possible within the range not to cause problems of solvent resistance and VOC (being volatile Organic Compounds), but it is more preferable, as much as possible, not to use any. When required, the added amount is preferably 0.1-5%, but more preferably 0.1-3%.

Further, it is also possible to employ a cationically polymerizable compound exhibiting a long lifetime as an initiator together with an initiator to make a radical·cation hybrid-type curable ink. This is also an effective means to prevent decrease of sensitivity due to a shielding effect of the coloring material existing in the ink.

In an ink-jet recording method of this invention, it is preferable to form an image using more than two kinds of ultraviolet ray curable inks which have differing infrared ray absorbability from the viewpoint of attaining the targeted effect of this invention. In cases when a secondary color image or a black image is formed with more than two kinds of ultraviolet ray curable inks, which have differing infrared absorbability, it is difficult to attain high quality image due to uneven ultraviolet ray curability resulting in temperature irregularity of ink caused by differing infrared absorbability of different ink colors. However, application of a light-flash source capable of filtering a part of the infrared wavelength region, which device is defined in this invention, and as a result, high quality images can be attained.

In this invention, more than two kinds of ultraviolet ray curable inks having differing infrared absorbability include, for example, a dark yellow ink, a dark magenta ink, a dark cyan ink, a black ink, a white ink, a light yellow ink, a light magenta ink, a light cyan ink, an orange ink, a green ink, and a transparent ink.

### [Production Method and Characteristics of Ultraviolet Ray Curable Ink]

In the production method of ultraviolet ray curable ink of this invention, a method of mixing coloring materials such as a dye and a pigment is not specifically limited, but, a mixing method of pigments, for example, is to be as follows. Using pigments as coloring materials, a polymerizable compound as a medium, a solvent, and a polymer dispersing agent, and adding any appropriate additives, these are mixed and dispersed. As a mixing/dispersing apparatus, cited examples are various mills such as the above ball mill and sand mill, as well as a dispersing machine such as a homogenizer.

The ultraviolet ray curable ink of this invention exhibits a viscosity of 15-500 mPa·s at 25° C., and further, surface tension preferably in the range of 22-38 mN/m, but more preferably in the range of 24-35 mN/m in order to attain appropriate ink dot leveling and adhesion after the ink is deposited on a recording medium.

Further, ink viscosity during ejection is preferably brought to 6-20 mPa·s by heating to control temperature, from the viewpoint of ink-jet recording.

In the ultraviolet ray curable ink of this invention, as ejection conditions of the ink from an ink-jet recording head, it is preferable that the recording head and the ink are heated to 35-100° C. and the ink is ejected after being heated to this range from the viewpoint of ejection stability. The ultraviolet ray curable ink exhibits a large viscosity fluctuation range due to temperature changes, and viscosity fluctuation directly affects droplet size and droplet ejection rate, resulting at least in deterioration of image quality, it is therefore essential that the ink temperature is raised and kept that temperature. Regarding control fluctuation of the ink temperature, it typically is the preset temperature ±5° C., preferably the preset temperature ±2° C., but more preferably the preset temperature ±1° C.

Further in this invention, it is preferable that the ink droplet volume ejected from each nozzle orifice of the ink-jet recording head is 2-40 pl. To form a highly defined image, it has been found via practice that the ink droplet volume needs to remain within this range.

### [Recording Medium]

As a recording medium employable in the ink-jet recording method of this invention, other than, for example, printing paper such as high quality paper and coated paper, a non-absorptive base support may be employed. In fact it is preferable to employ a non-absorptive support as a recording medium.

In this invention, as a non-absorptive base support, various non-absorptive plastic compositions and films thereof may be employed. As examples of various such plastic films, cited may be polyethylene terephthalate (PET), drawn polystyrene (OPS), drawn nylon (ONy), drawn polypropylen (OPP), polyvinylchloride (PVC), various polyolefin films, PE film, and TAC film. As other plastics, employed may be polycarbonate, an acryl resin, ABS, polyacetal, PVA, and various kinds of rubber. Further, various metals and glass are applicable. Of these recording media, when forming an image on films of PET, OPS, OPP, ONy, and PVC, which are possible to be shrinkable specifically via heat, the composition of this invention is effective. Not only do these recording media tend to cause film curling and deformation with curing/shrinking of the ink, or heat generation during the curing reaction, but further, the ink layer tends not to follow shrinkage of the recording media.

In the ink-jet recording method of this invention, as exposure conditions of the flashing light which range is reduced in the infrared wavelength region of this invention, it is preferable that the duration of the light-flash is 0.001-2.0 seconds after the ink has been deposited, but more preferably 0.001-1.0 second. To prevent ink beading on and ink bleeding in the recording medium, to attain a highly defined image, specifically important is for irradiation to be as short as possible. The light-flash is preferably activated for multiple times, whereby more efficient curing is realized.

With this method, efficient ink fixation can be realized in a very short time, without unnecessary heating of the recording medium and/or members surrounding the head such as the platen, compared to an apparatus incorporated a light-source such as a high pressure mercury lamp near the recording head unit. Further, such light-flash source is inexpensive and low-weight compared to a high pressure mercury lamp.

### [Ink-jet Recording Apparatus]

Next, the ink-jet recording apparatus (hereinafter, referred to simply as the recorder) of this invention will be detailed referring to suitable figures. In addition, the recorder shown in the figures is definitely one of the preferable embodiments of this invention, but this invention is not limited to the figures shown here.

FIG. 2 shows an ink-jet recording apparatus which may be used in this invention, and is a front view showing an example of the typical features used in a serial print method. Recording Apparatus 1 is constituted of Head Carriage 2, Recording Head 3, Light-flash Source 4 as an exposure device, and Platen Section 5. In this Recording Apparatus 1, Platen Section 5 is installed under Recording Medium 20. Installed in front of the emission section of Light-flash Source 4, is Infrared. Light Cut-off Filter 41, which reduces the amount of light of an infrared region, which for example, may be a cold filter which reflects near-infrared rays and transmits light below the visible wavelength range.

Platen Section 5 functions to absorb ultraviolet rays, and absorbs excessive ultraviolet rays which have passed through Recording Medium 20. As a result, a very stable highly defined image can very stably be reproduced.

Recording Medium 20 is guided by Guide Member 6, and is conveyed from near side toward the back of FIG. 2 by actuation of a sheet conveying device (not shown). A head scanning device (also not shown) reciprocates Recording Head 3 mounted on Head Carriage 2 via the reciprocation of Head Carriage 2 in direction Y in FIG. 2.

Head Carriage 2 is installed in the upper portion of Recording Medium 20, and houses a plurality of Recording Heads 3, as detailed later, with the ink ejection orifices arranged downward, based on the number of colors used for image printing on Recording Medium 20. Head Carriage 2 is mounted on the body of Recording Apparatus 1 with reciprocation in direction Y in FIG. 2, and driven by a head scanning device.

In addition, Head Carriage 2 in FIG. 2 is shown to house Recording Heads 3 of yellow (Y), magenta (M), cyan (c), and black (K), but in the case of the actual operation, the number of colors in Recording Heads 3 housed in Head Carriage 2 may be determined as appropriate.

Recording Heads 3 eject the ultraviolet ray curable ink of this invention, provided with an ink supply means (not shown in Figs.), toward Recording Medium 20 from ink ejection orifices via operation of plural ejection device (not shown) installed inside the recording heads. The ultraviolet ray curable inks ejected from Recording Heads 3 include coloring materials and photo polymerizable compositions, and exhibit the characteristic to be cured via irradiation of ultraviolet rays for a polymerization reaction.

Recording Head 3 ejects the ultraviolet ray curable ink as ink droplets on a predetermined region under Recording Medium 20 (a region defined for deposition) to deposit ink droplets within said region as ink droplets during scanning of one end of Recording Medium 20 to the other end in direction Y, driven by the head scanning device.

After the above-described scanning is repeated an appropriate number of times to eject the ultraviolet ray curable ink within the limits of the region, Recording Medium 20 is shifted from near side toward the back of FIG. 2 by a shifting device and the ultraviolet ink is ejected within the limits of the next adjacent region along the back of FIG. 2 against the above-described region by Recording Head 3 while again performing a scan by a shifting the head scanning device.

By repeating the above operations to eject ultraviolet ray curable ink from Recording Head 3 synchronously with the head scanning device and the conveyance device, an image comprised of an aggregate of ultraviolet ray curable ink droplets is formed on Recording Medium 20.

In this invention, a flash lamp, such as a xenon flash lamp is preferable as Light-flash Source 4.

In relation to Recording Medium 20, Light-flash Source 4 is fixed more-or-less parallel and is installed on both sides of Head Carriage 2. When any ink is ejected from the recording head during the scanning (being horizontal scanning) in direction Y of Head Carriage 2, any ink droplet ejected on the recording medium will be cured during movement of the carriage via exposure of intermittent light-flash via Light-flash Source 4 on the opposite side of the moving direction of the carriage. With the gap between Light-flash Source 4 and Recording Medium 20, intensity of the flashing light of an ink ejection section can be adjusted. Further, Timing of exposure of the light-flash can be adjusted with the distance between Recording Head 3 and Light-flash Source 4.

The light-flash source intermittently irradiates, {(flash exposure width)×(flash cycle)} against to the moving distance per unit time of the recording head on the recording medium, is set to be at least one. This means that the scanning distance (being limited region for ink droplet deposition) is covered with at least one flashing, and of course, the region may be subjected to plural light-flashes, and is preferably so subjected at least twice. This general lure is applicable to recording via a serial, a line and a drum method.

In order to control illuminance within the ink ejection section, so that the ink is not cured by irradiation of a light-flash before it is deposited onto the recording medium, the following controls have been shown to be effective: light shielding of entire Recording Head 3; further, distance h1 between Ink Ejecting Section 31 of Recording Head 3 and Recording Medium 20 is increased more than distance h2 between Light-flash Source 4 and Recording Medium 20 (namely h1<h2); distance d between Recording Head 3 and Recording Medium 20 is increased (namely increasing d). Further, it may be preferable to provide Bellows Structure 7 between Recording Head 3 and Light-flash Source 4.

In the serial print method, the UV curable ink ejected from the recording head is irradiated by the flashing light emitted from Light-flash Source 4 mounted on the carriage over 0.001-2.0 seconds after ink deposition, but preferably 0.001-1.0 second while the carriage is conveyed along direction Y. To attain formation of a highly defined image, it is important that the irradiation is conducted as quickly as possible after deposition. Further, especially in cases of rapid printing, the carriage moves very fast tending to result in lack of sufficient irradiation energy, and thus, timing and cycle of flashes, and flash exposure width (irradiation areas in the main scanning width direction) meet to be adjusted, so that exposure is conducted via multiple flashes.

As mentioned above, in reference to FIG. 2, the serial print method was described as an example, and in addition to this, the ink-jet recording apparatus of each ink-jet recording method shown in FIG. 3 may also be employed.

In FIG. 3 (a), Recording Head 19 is arranged perpendicular to the conveyance direction of Recording Medium 20, since printing is conducted while the recording medium is conveyed, and the flashing light is irradiated from Light-flash Source 24. (This is in regard to the line head method.) In FIG. 3 (b), printing is conducted while Recording Head 19 moves in the sub-scanning direction, while the flashing light is again provided by Light-flash Source 24. (This is a flat head method.) In FIG. 3 (c), printing is conducted while Recording Head 19 also reciprocates perpendicular to the conveyance direction of Recording Medium 20, and further, intermittent light-flash irradiates from Light-flash Sources 24 from both sides of the head. (This is in regard to the serial print method.)

### EXAMPLE

In the following, the present invention is specifically described referring to examples, but this invention is by no means limited thereto. In addition, “part” means “weight part”, unless otherwise specified.

### Example 1

Ink-jet inks were prepared as follows.

### <<Preparation of Ink-jet Ink>>

### <Preparation of Ink 1 (Cyan)>

| | | |
|---|---|---|
| C.I. Pigment Blue 15:3 | 5 | parts |
| Tetraethylene glycol diacrylate | 43 | parts |
| ε caprolactam modified dipentaerythritol | | |
| hexaacrylate | 20 | parts |
| Phenoxyethyl methacrylate | 30 | parts |
| Polymerization initiator (Irgacure-907: | 2 | parts |
| Produced by Ciba-Geigy AG) | | |

### <Preparation of Ink 2 (Magenta)>

| | | |
|---|---|---|
| C.I. Pigment Red 57:1 | 5 | parts |
| Tetraethylene glycol diacrylate | 43 | parts |
| ε caprolactam modified dipentaerythritol | 20 | parts |
| hexaacrylate | | |
| Phenoxy ethyl methacrylate | 30 | parts |
| Polymerization initiator (Irgacure-907: | 2 | parts |
| produced by Ciba-Geigy AG) | | |

### <Preparation of Ink 3 (Yellow)>

| | | |
|---|---|---|
| C.I. Pigment Yellow-13 | 5 | parts |
| Tetraethylene glycol diacrylate | 43 | parts |
| ε caprolactam modified dipentaerythritol | 20 | parts |
| hexaacrylate | | |
| Phenoxy ethyl methacrylate | 30 | parts |
| Polymerization initiator (Irgacure-907: | 2 | parts |
| produced by Ciba-Geigy AG) | | |

### <Preparation of Ink 4 (Black)>

| | | |
|---|---|---|
| Carbon black | 5 | parts |
| Tetraethylene glycol diacrylate | 43 | parts |
| ε caprolactam modified dipentaerythritol | 20 | parts |
| hexaacrylate | | |
| Phenoxy ethyl meth acrylate | 30 | parts |
| Polymerization initiator (Irgacure-907: | 2 | parts |
| produced by Ciba-Geigy AG) | | |

Each of Inks 1-4 prepared above was loaded in the apparatus shown in above FIG. 2, and a printing test was conducted as follows. The test conditions were: using the ink-jet recording heads shown in above FIG. 2, which was set to have a driving cycle of 4 kHz, to continuously eject 4 droplets of 4 μl per cycle, and these conditions enabled expression of 5 gradations. Four passes recorded a 720 dpi×720 dpi (dpi means dot numbers per inch or 2.54 cm). Ink temperature was maintained at 55° C. by heating the ink flow passage, the ink chamber, and the nozzles.

As a recording medium, 110 μm Yupo SGG#110, produced by Yupo Corp., was employed.

Further, after printing, the ink which was ejected onto the recording medium from the recording head during carriage transfer in the main scanning direction, was intermittently irradiated by Light-flash Source 4 (featuring a xenon flash lamp). The carriage rate was 500 mm/s (main scanning), at the energy per flash onto the recording medium was 3.0 J/cm². Further, Light-flash Source 4 exhibited a flash emission time (half bandwidth) of 0.8 msec, and was driven at a frequency of 10 Hz. The flash exposure width (being the light-source width) was 100 mm, and at the main scanning rate of the above carriage, {(flash exposure width)×(flash cycle)} was set at two against the scanning distance per unit time of the recording head. (In summary, a single reciprocal scanning cycle covered two areas of flash exposure.)

In this case, the cold filter which filtered light of more than 700 nm, was installed in front of the light-flash source, and ratio (A/B) of light amount (A) at a wavelength range of 250-400 nm to light amount (B) at a wavelength range of 800-1,100 nm was set at 0.6, after which comparison of image characteristics with and without the filter was conducted.

The obtained samples were evaluated with respect to the following characteristics.

### <<Bumping of Ink>>

Solid image portions on the recording medium after printing were visually observed, and if any evaporated component of the monomer was adhered around a solid image portion, it was ranked as C, while when no adhesion was noted, it was ranked as A, and when only slightly adhered, it was ranked as B.

<<Wrinkles Generated during Curing (Wrinkles due to Curing)>>

Solid image portions were visually observed, and when it was noted that glossiness was not decreased by cured wrinkles, it was ranked as A, when slightly noted, it was ranked as B, and when readily noted, it was ranked as C.

### <<Adhesion>>

After 25 mm wide Cellotape (a registered trademark) was firmly adhered, via finger pressure, onto the surface of solid image portions, after which the tape was quickly peeled off at a peeling angle of 90°, and the degree of peeling was observed.

A: No peel-off of image portions was noted.

B: Slight peel-off of image portions was noted.

C: Obvious peel-off of image portions was noted.

The above valuation results are shown in Table 1.

TABLE 1

| | Light | | | | |
|---|---|---|---|---|---|
| | filtered at | | Wrinkles | | |
| Ink | more than | Bumping | due to | | Within/Beyond |
| No. | 800 nm | of ink | Curing | Adhesion | this invention |
| 1 | Yes | A | A | A | Within this |
| | | | | | invention |
| 2 | Yes | A | A | A | Within this |
| | | | | | invention |
| 3 | Yes | A | A | A | Within this |
| | | | | | invention |
| 4 | Yes | A | A | A | Within this |
| | | | | | invention |
| 1 | No | B | B | B | Beyond this |
| | | | | | invention |
| 2 | No | B | B | B | Beyond this |
| | | | | | invention |
| 3 | No | B | B | B | Beyond this |
| | | | | | invention |
| 4 | No | C | C | C | Beyond this |
| | | | | | invention |

### Example 2

Further, using Inks 1-4 and the ink-jet recording apparatus employed in Example 1, transmittance of a cold filter which filtered light of more than 700 nm was adjusted to a setting ratio (A/B) of 0.4, in which an amount of light (A) was in wavelength range of 250-450 nm, and an amount of light (B) was in wavelength range of 800-1,100 nm.

Evaluation similar to Example 1 was conducted, the results of which are shown in Table 2.

TABLE 2

| | Light | | | | |
|---|---|---|---|---|---|
| | filtered at | | Wrinkles | | |
| Ink | more than | Bumping | due to | | Within/Beyond |
| No. | 800 nm | of ink | Curing | Adhesion | this invention |
| 1 | Yes | A | A | A | Within this |
| | | | | | invention |
| 2 | Yes | A | A | A | Within this |
| | | | | | invention |
| 3 | Yes | A | A | A | Within this |
| | | | | | invention |
| 4 | Yes | B | B | B | Within this |
| | | | | | invention |

As is clear from Tables 1 and 2, it is proven that the samples prepared with light-flash, infrared region of which was partially filtered off under the conditions defined in this invention, exhibited the targeted characteristics.

1. An ink-jet recording apparatus which is equipped with a light-flash source,
wherein the ink-jet recording apparatus has a device to reduce an amount of light within at least an infrared wavelength region emitted from the light-flash source.

2. The ink-jet recording apparatus described in claim 1,
wherein the device to reduce the amount of light within the infrared region is a device to reduce at most by half the amount of light at 800-1,100 nm.

3. An ink-jet recording method comprising the steps of:
(a) ejecting an ultraviolet ray curable ink onto a recording medium, and
(b) curing to fix the ejected ink using light-flash emitted from a light-flash source,
wherein the light flash is one in which at least a part of an amount of light is reduced in an infrared wavelength region.

4. The ink-jet recording method described in claim 3,
wherein an amount of light of the light flash is reduced at most by half in wavelengths between 800-1,100 nm.

5. The ink-jet recording method described in claim 3,
wherein ratio (B/A), of an amount of light (B) at 800-1,100 nm of the wavelength of the flashing light to an amount of light (A) at 250-450 nm, is at most half.

6. The ink-jet recording method described in claim 3,
wherein the total content of water and a water soluble solvent in the ultraviolet ray curable ink is at most 5 weight % based on the total weight of the ultraviolet ray curable ink.

7. The ink-jet recording method described in claim 3,
wherein an image is formed using two or more kinds of ultraviolet ray curable inks which exhibit different infrared absorption capability.

8. An ultraviolet ray curable ink used for the ink-jet recording method of claim 3.

9. The ultraviolet ray curable ink described in claim 8,
wherein the total content of water and a water soluble solvent in the ultraviolet ray curable ink is at most 5 weight % based on the total weight of the ultraviolet ray curable ink.
